(19) United States
(12) Patent Application Publication
(10) Pub. No.: US 2010/0059583 A1
(43) Pub. Date: Mar. 11, 2010

(54) DOUBLE POSTCARD

(75) Inventors: Robert A. Stier, Papillion, NE (US); Glen D. Wordekemper, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/206,552

(22) Filed: Sep. 8, 2008

(51) Int. Cl. B65D 27/06; B42D 15/00

(52) U.S. Cl. 229/300; 229/92.8

(57) ABSTRACT

A double postcard mailer has personal information on an interior face, which is concealed by a panel. The panel is affixed to the interior face with adhesive, except at a flap having a tab extending form the panel. The panel can be removed to reveal the personal information by pulling the tab and separating the panel from the interior face. In some embodiments, the panel is perforated and the panel tears at the perforations in order to remove a portion of the panel and reveal the information. In other embodiments, the flap is affixed to an opposing interior face, so that as the double postcard is opened, portions of the panel are removed by staying attached to the opposing interior face.

### BACKGROUND OF THE INVENTION

Postcards and similar mailers are commonly used to communicate with consumers. They have cost advantage to the sender in that they may be mailed at a reduced postcard rate rather than a standard first-class mail letter rate.

One such mailer is a “double postcard,” which is essentially two cards or sections, one being the original card to an addressee or consumer, and other being a detachable reply card to be mailed back by the consumer. The two cards are created, for example, by folding the mailer so that the cards are attached at one end along a perforated fold line, and “sealed” or affixed at the other end by adhesive, a sticker, a staple, or the like. The double card is opened by the consumer by breaking the sealed end. There is usually a message to the consumer on the back side of the original card, inviting the consumer to return the reply card (sometimes with information entered by the consumer). If the consumer is interested in replying, the cards are separated at the perforated line, and the reply card is mailed by the consumer.

Double postcards are used for a wide variety of purposes. As examples, they are used for advertising or promotional purposes (with the reply card used by the consumer to request additional information on the goods or services being promoted). They are also used by banks, creditors, merchants or other institutions with whom the consumer has an account, when there is some action needed by the consumer (e.g., the account has been overdrawn or is overdue, and the consumer is asked to authorize a transfer—using the reply card—to bring the account current).

Thus, in many of the circumstances where a double postcard is used, the original card may have personal or confidential information on its back side (the interior of the double card). Although the card is sealed (in the sense of being attached at the end opposite the fold line), current postal requirements require that the card not be sealed on the two sides. This is to ensure compliance with postal regulations designed to permit inspection of the interior of double card (the double card may thus be flexed by an inspector to reveal the interior). However, such inspection by an inspector (or any other person having access to the mailer) would provide access to the personal or confidential information printed on the interior of the cards.

### BRIEF SUMMARY OF THE INVENTION

There is provided, in accordance with embodiments of the present invention, a double postcard mailer in which a panel concealing personal information can be readily removed using a flap on the panel.

In some embodiments, a double postcard mailer includes a sheet having first and second postcard size sections connected by a fold line which separates the first and second sections. Each of the sections has an exterior face and an interior face, the interior faces opposite each other when the sheet is folded along the folding line, with information on the interior face of at least one of the first and second sections. A panel is at least partially affixed (e.g., by adhesive) to the interior face having the information thereon, in order to conceal at least some of the information. A flap on the panel is not affixed to the interior face and may be used to remove the panel from the one of the sections.

In one embodiment, the flap includes a tab that can be pulled to facilitate removal of the panel. In other embodiments, the panel includes perforations which permit a removable portion of the panel to be torn away. The removable portion of the panel can be affixed to an opposing face of the mailer, in order to pull the panel away as the double postcard is opened by a recipient.

A more complete understanding of the present invention may be derived by referring to the detailed description of the invention and to the claims, when considered in connection with the Figures.

### BRIEF DESCRIPTION OF THE DRAWINGS

FIG. 1 is a view of a mailer, prior to being folded into a double postcard, according to one embodiment of the invention.

FIG. 2 illustrates the mailer of FIG. 1, viewed from the opposite side seen in FIG. 1.

FIG. 3 is a perspective view of the front of mailer, after being folded at one end and sealed at the other end.

FIG. 4 is a rear perspective view of the mailer.

FIG. 5 is the same view as in FIG. 4, but with the reply card removed to better reveal the interior face of the original card.

FIG. 6 is a view similar to FIG. 2, illustrating an alternate embodiment of the invention.

### DETAILED DESCRIPTION OF THE INVENTION

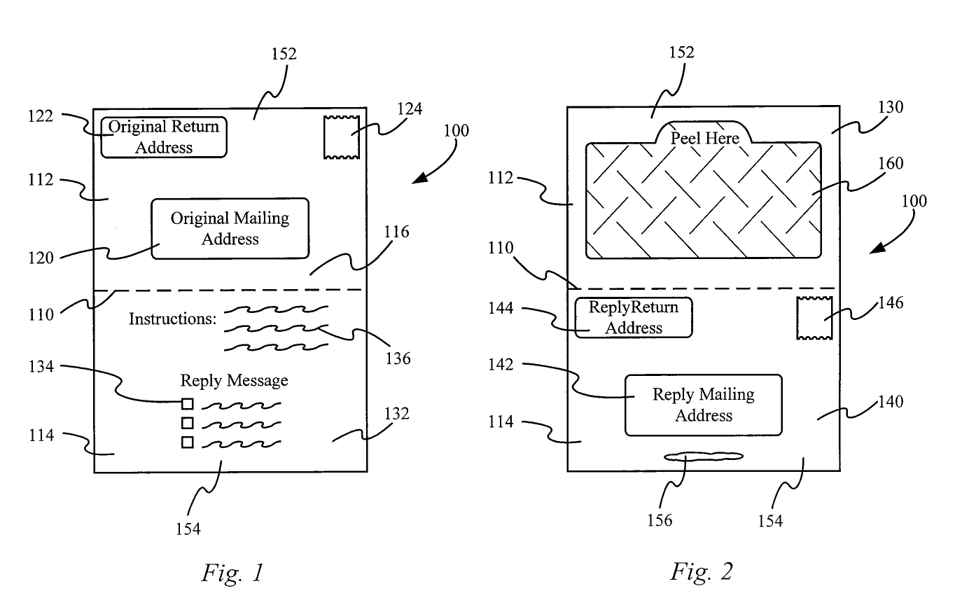

There are various embodiments and configurations for implementing the present invention. One such implementation is illustrated in FIGS. 1 and 2, where according to one embodiment of the invention, a single sheet mailer 100 is seen. FIG. 1 shows one side of the mailer 100, and FIG. 2 shows the opposite side of the same mailer 100.

The mailer 100 is sized so that when folded along a weakened or perforated line 110, the mailer forms a double postcard having a postcard size (e.g., about 4.25 inches by 6 inches). The views in FIGS. 1 and 2 are of the mailer 100 prior to being folded, with the mailer seen as comprising two sections or cards, an original postcard 112 and a reply postcard 114 (each having a postcard size). The original postcard has an exterior face 116 with standard postcard mailing information, such as an original mailing address 120 (e.g., the address of the original recipient or consumer to whom the double postcard is being sent), an original return address 122 (the address of the sender), and a postage or franking location 124. The original postcard 112 also has an interior face 130 (FIG. 2), having personal or confidential information printed thereon (not visible) that is covered by a removable panel 160, to be described in greater detail later.

The reply postcard 114 has an exterior face 132 (FIG. 1) with a location 134 for entering information or a reply message from the recipient (e.g., check boxes, blank lines or similar means). There may also be a location 136 for instructions to the recipient on filling out the reply card. The reply card 114 has an interior face 140 (FIG. 2) with standard postcard mailing information for the reply card, such as a reply recipient mailing address 142 (for the reply recipient, i.e., the original sender or a third party recipient), a reply or return address 144, and a postage or franking location 146.

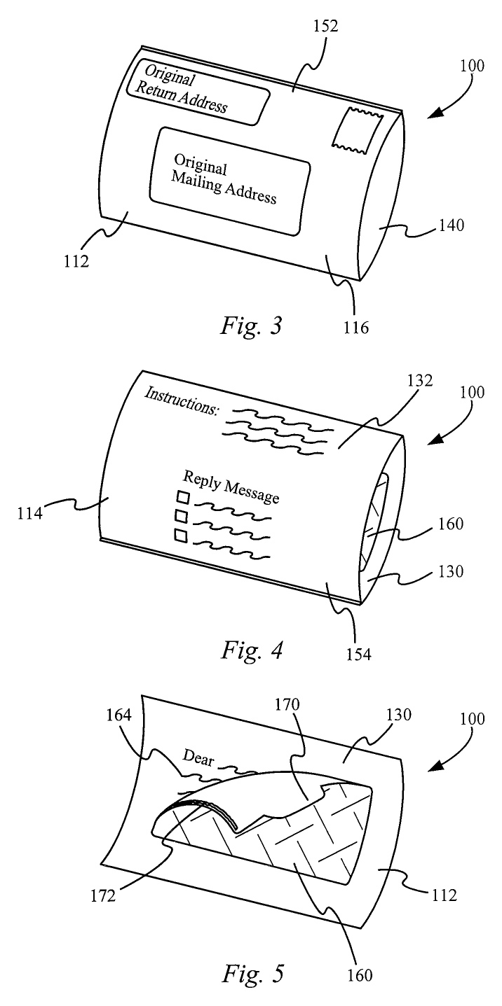

It should be appreciated that the use of the terms “exterior” and “interior” reflect the location of various faces of the mailer 100 when folded at line 110 to form the double postcard (the folded card can be best seen in FIGS. 3 and 4). Thus, the exterior faces 116 and 132 would be visible on the outside (as the front and back, respectively) of the double postcard and the interior faces 130 and 140 would be on the inside of the double postcard (until the double postcard is opened by the recipient). The ends 152 and 154 of the mailer (opposite the perforated line 110 when the card is folded) are affixed to each other, such as by adhesive at location 156 (FIG. 2) prior to being mailed to a recipient. Of course, other means for affixing ends 152 and 154 could be used, such as a sticker, staple, or wafer seal.

It should be further appreciated that, although the orientation of the information on the various faces of the mailer are illustrated in the drawings in order to more easily understand the construction of the mailer, they could be arranged other than as illustrated. As an example, if the mailer 100 of FIGS. 1 and 2 is folded along line 110 as seen, the information on exterior face 132 would appear as inverted or “upside down” relative to the information on the exterior face 116. If this were undesired, the information printed on face 132 could be inverted relative to that seen in FIG. 1.

Turning now to FIGS. 3, 4 and 5, further features of the mailer 100 are illustrated. In FIGS. 3 and 4, the mailer is seen after being folded and secured at ends 152 and 154. Note that in FIG. 4 (illustrating the backside of the mailer), the mailer had been turned or inverted so that the information on exterior face 132 is seen “right side up.” Further, in FIGS. 3 and 4, the mailer is shown “flexed” to reveal the interior faces 130 and 140 of the mailer. This flexing position is somewhat similar to what might occur if a postal inspector were to inspect the inside of the mailer 100, in order to assure compliance with postal regulations (e.g., regulations that make it impermissible to have enclosures within the mailer 100). As should be appreciated, the flexing is facilitated by the attachment of the original card 112 and reply card 114 at perforated line 110 (FIG. 1), and the sealing or attachment of the ends 152 and 154 (but without the two sides of the cards being attached or affixed to each other).

In order to understand the use of the panel 160 in concealing information on the interior face 130, reference can be had to FIG. 5, which shows the mailer in a view similar to that of FIG. 4, but with the reply card 114 removed. As seen, the panel 160 covers information 164 written or printed at an information location on the interior face of 130 of the original postcard 112. The panel 160 is opaque so that the information 164 cannot be read, and as illustrated, may have a printed security pattern or other substance on it to assure that the confidential information could not be viewed by holding the mailer up to light and thereby attempting to see through the panel 160.

The panel 160 has a tab 170 to permit the panel to be removed from the interior face 130 by the intended recipient (the panel is seen partially removed in FIG. 5). The tab may be pulled to peel off the panel, with the panel removably affixed or glued to the card 114 (e.g., by glue or other adhesive) at locations 172 around its periphery, other than at or near the tab 170. The panel would not be glued at the tab 170, to permit the tab to be used as a flap that can be lifted by the recipient. In order to facilitate removal, the glue or adhesive used to affix the panel to the card 112 should be of a type that permits separation of the panel from the card 112, such as a quick release or deadened adhesive.

Alternatively, the glue locations 172 on the panel could be separated from the center of the panel 160 by perforated lines (not shown in the drawings), so that the panel center can be removed for access to the confidential information 164 by tearing along the perforated lines as the tab 170 is pulled.

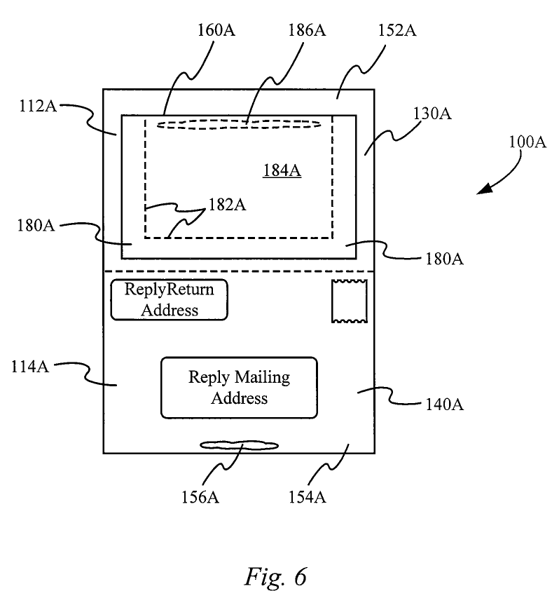

Another embodiment is illustrated in FIG. 6, where a mailer 100A is seen. In this embodiment, the flap portion of the panel 160A has no tab 170. Rather, the panel 160A has glued portions 180A (between the edges of the panel and perforated lines 182A) that are generally not separable from card 112A. A panel center 184A of the panel 160A is also glued to the interior face 140A of the reply card 114A at a location 186A, so that as the mailer 100A is opened, the panel center 184A tears away at the perforated lines 182A from the glued portions 180A (which remain at card 112A), thereby revealing the concealed personal information underneath the center 184A of the panel.

As should be appreciated, the use of glues or adhesives having varying degrees of adhesion will facilitate the proper use of the mailer 100A. For example, the adhesive at glue location 156A will have the least adhesion, so that the seal holding together end 152A of card 112A and end 154A of card 114A can be easily broken by the recipient in order to open the mailer 100A. The adhesive holding glued portions 180A on the panel 160A to card 112A will need a relatively high degree of adhesion, since the glued portions will need to remain with card 112A as the panel center 184A is separated.

The adhesive at location 186A holding the panel center 184A to the card 114A as the mailer is opened needs to have a sufficiently high degree of adhesion to ensure that center panel 184A stays with card 114A. However, it must be sufficiently separable to permit the center panel to removed from card 114A in order for the recipient to use card 114A as a reply postcard.

As should be further appreciated, the degree of adhesion at glue location 186A may depend on the strength of the perforated lines 182A. The weaker the lines 182A, the less adhesion is needed at glue location 186A.

The following table indicates an example of the adhesives for the glue locations 156A, 180A and 186A:

| Glue Location | Adhesive |
|---|---|
| Location 156A | encapsulated pressure, contact or |
| | liquid adhesives |
| Location 180A | quick release or deadened |
| | adhesives |
| Location 186A | quick release or deadened |
| | adhesives |

In some embodiments, the perforated lines 182A could be eliminated, and in that case a lower degree of adhesion would be needed at glued portions 180A. In such embodiments, the mailer 100A would have the entire panel 160A separate from the card 112A at the glue portions 180A as the mailer is opened, in lieu of having panel 160A tear along the perforated lines 182A.

While a detailed description of presently preferred embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A double postcard mailer, comprising:
a sheet having first and second postcard size sections connected by a fold line which separates the first and second sections;
each of the sections having an exterior face and an interior face, the interior faces opposite each other when the sheet is folded along the folding line;
an information location on the interior face of at least one of the first and second sections, the information location having information written thereon;
a panel affixed to the one of the sections having the information thereon, in order to conceal at least some of the information; and
a flap on the panel which is not affixed to the one of the sections on the sheet and which may be used to remove the panel from the one of the sections.

2. The mailer of claim 1, wherein the panel is affixed to the one of the sections by adhesive, with the adhesive omitted at the flap.

3. The mailer of claim 1, wherein the flap comprises a tab extending from the panel.

4. The mailer of claim 1, wherein the first section is a postcard having an original recipient mailing address, and the second section is a reply postcard detachable from the first section having a reply recipient mailing address.

5. The mailer of claim 4, wherein the information is on the interior face of the first section.

6. The mailer of claim 4, wherein the fold line separating the first and second sections is weakened so that the fold line may be torn in order to detach the second section from the first section and in order for the second section to be mailed as a reply card.

7. The mailer of claim 4, wherein the fold line is perforated, and wherein the ends of the first and second sections opposite the fold line are affixed prior to mailing of the mailer to the original recipient.

8. The mailer of claim 4, wherein the first and second sections are affixed at the opposite ends by an adhesive applied to the interior face of at least one of the first and second sections.

9. A mailer, comprising:
a sheet having first and second postcard size sections connected by a weakened fold line which separates the first and second sections;
each of the sections having an exterior face and an interior face, wherein the interior faces are opposite each other when the sheet is folded along the folding line and wherein the interior face on at least one of the first and second sections has information thereon;
a panel affixed to the interior face of the one of the sections having the information thereon in order to conceal at least some of the information; and
a removable portion of the panel connected to a remaining portion of the panel by at least one weakened line of reduced strength, to permit separation of the removable portion from the remaining portion of the panel.

10. The mailer of claim 9, wherein the fold line is perforated.

11. The mailer of claim 9, wherein the removable portion of the panel is affixed to the opposing interior face of the other of the sections, so that when the first and second sections are separated, the removable portion remains with the opposing interior face as the removable portion of the panel separates from the remaining portion of the panel.

12. A mailer, comprising:
a sheet having first and second sections connected by a fold line which separates the first and second sections, so that when folded along the fold line the sheet has a postcard size;
an interior face on each of the first and second sections when the sheet is folded, with at least one of the interior faces having information thereon;
a panel affixed to the interior face having the information thereon, in order to conceal at least some of the information; and
a flap on said panel, the flap having an end defined by at least a portion of the periphery of the panel, the panel affixed to the interior face other than at the end of the flap, so that the flap may be used to remove at least a portion of the panel from the interior face.

13. The mailer of claim 12, wherein the end of the flap includes a tab extending from the panel.

14. The mailer of claim 13, wherein the panel is affixed to the interior face by an adhesive that permits the panel to be removed from interior side when the flap is pulled from the interior side.

15. The mailer of claim 12, wherein a removable portion of the flap is connected to a remaining portion of the panel by a perforation, so that the flap is removed from the panel by tearing the perforation.

16. The mailer of claim 12, wherein the ends of the sections opposite the folding line are removable attached, so that when the ends are detached, the interior face having the information is exposed.

17. The mailer of claim 12, wherein the panel is opaque.

18. The mailer of claim 12, wherein the panel has a security pattern printed thereon to prevent viewing of the information when the label is affixed to the interior face.

19. The mailer of claim 12, wherein the mailer is sent by an institution to an account holder, and wherein the information is personal account information.
